(19) United States
(12) Patent Application Publication
(10) Pub. No.: US 2005/0108437 A1
(43) Pub. Date: May 19, 2005

(54) Interconnection of ip networks

(76) Inventor: John Loughney, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/491,148

(22) PCT Filed: Sep. 27, 2002
(86) PCT No.: PCT/IB02/04192

(30) Foreign Application Priority Data
Sep. 28, 2001 (GB) 0123371.7

(51) Int. Cl. G06F 15/16

(52) U.S. Cl. 709/249

(57) ABSTRACT

There is disclosed a broker entity for an IP network, the IP network being in communication with a further IP network via at least one data network, wherein all communication to and from the IP network is via the broker entity.

The present invention relates to internet protocol (IP) networks, and more particularly to the interfacing of mobile wireless Internet protocol (IP) networks via the Internet.

In third generation (3G) mobile networks, architectures are being specified which have all Internet protocol (IP) communication. In order to have communication between networks associated with different operators, it is necessary to provide a transport structure for IP communication between those different networks.

Various transport bearer services are well-known for providing a control plane bearer for services between different IP networks. An example of one such transport bearer service is the stream control transmission protocol (SCTP). SCTP was originally designed with Signalling System #7 (SS7) over Internet Protocol (IP) in mind. However SCTP has evolved through extensions to be a protocol suitable for any service that wants to take advantage of multi-homing. As such its use has been proposed for IP networks.

The known use of the SCTP protocol relies upon direct communication between network elements, from an element in one network to an element in another network. In utilising the SCTP protocol in IP networks, however, such a technique has certain drawbacks. The addressing of some IP networks, e.g. 3G Core Networks, may be private and/or confidential. When connection between network elements of different operators is needed, the private addressing schemes of the network may not allow direct connection between network elements. Therefore the known SCTP protocol is not suitable.

Furthermore, there may be business/commercial reasons why a direct connection between network elements of different operators is undesirable, for example to ensure that network structures are hidden.

Scalability issues are also a concern. The proposed network element—to—network element approach may result in a large number of ad hoc interconnections between networks.

It is therefore an aim of the present invention to provide an improved technique for interconnecting IP networks via internets that overcomes the above-stated problems.

According to one aspect the present invention provides a broker entity for a first IP network, the first IP network being adapted to communicate with a second IP network via at least one data network, wherein communication between the first and second IP networks is via the broker entity.

Said broker entity may be common to the second IP network, or the second IP network may be provided with a second broker entity. Communication between the first and second IP networks may be via the first and second brokers.

The data network, or internet, is preferably one of: the Internet, an intranet, or an extranet.

The broker entity may contain a connection manager. The broker entity may further include a traffic filter. The traffic filter may act as a firewall. The broker entity may include a load balancer. The broker entity may include an address selector. The address selector may select a network endpoint.

The network is preferably a wireless network.

According to a further aspect the present invention provides a method of communicating between a first IP network and a second IP network via at least one data network, the method comprising providing a broker entity in the IP network, wherein communication between the first and second IP networks is via the broker entity.

The broker entity may perform connection management between the local network and foreign networks. The broker entity may perform traffic filtering. The traffic filtering may be performed by a firewall. The broker entity may perform load balancing. The broker entity may perform address selection. The address selection may identify a network endpoint.

The present invention thus provides a general broker architecture that may be used with SCTP to solve addressing issues, privacy issues, and scalability issues for signalling transport between multiple operator networks.

Brokers are preferably used between core networks as a way to allow private addressing and to allow scalability in global 3G networks. The brokers may be used for specific network elements, for example just home location resisters (HLRs), or to allow all network elements within a core network that may need connection to elements outside of their own network.

The invention will now be described by way of example with reference to the accompanying drawings, in which:

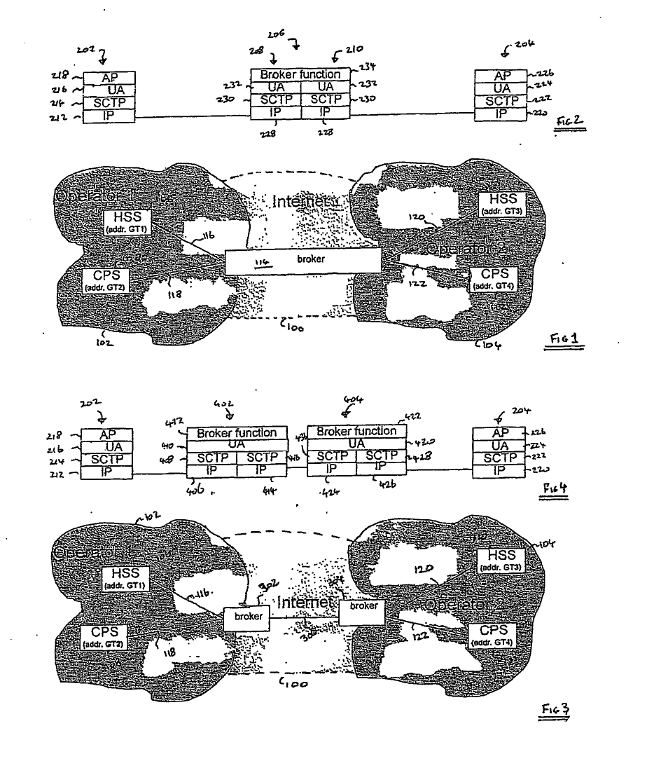

FIG. 1 illustrates functional blocks of a first embodiment of the present invention, utilising a common broker;

FIG. 2 illustrates the protocol layers for the embodiment of FIG. 1;

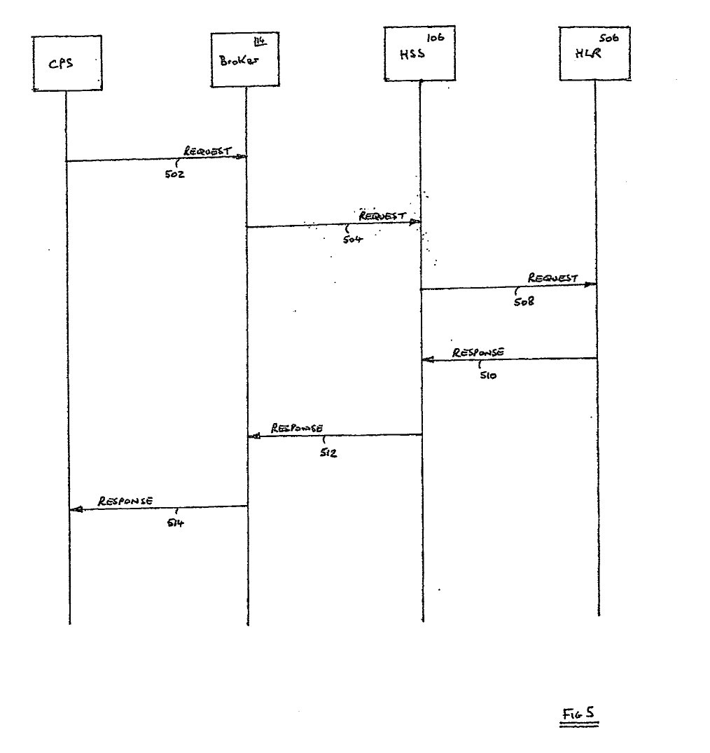

FIG. 3 illustrates functional blocks of a second embodiment of the present invention, utilising multiple brokers;

FIG. 4 illustrates the protocol layers for the embodiment of FIG. 3; and

FIG. 5 illustrates an example of a message flow in accordance with the invention in the embodiment of FIG. 1.

The present invention is described herein with reference to particular network environments. It will be understood, however, that the invention is more broadly applicable and may apply to any wireless IP network which interfaces with another wireless IP network via data networks.

Referring to FIG. 1 there is illustrated the functional blocks of a first example implementation of the present invention. A first network operated by a first network operator is generally designated by reference numeral 102. A second network operated by a second network operator is generally designated by reference numeral 104. Each of the first and second networks is an IP network. The respective networks 102 and 104 are distinct, independent networks with no common elements or connections there between. However, communication between the two networks is provided (in this example) via the Internet, generally designated by reference numeral 100.

Each network includes various network elements, which will be familiar to one skilled in the art. Only those network elements required for understanding the present invention are shown in FIG. 1. The network 102 includes a home subscriber server (HSS) 106 and a call-processing server (CPS) 108. Similarly the network 104 includes a HSS 110 and a CPS 112.

The home subscriber servers store subscriber related information of the respective networks. The subscriber information may include data such as registration identities (ID) of the subscriber or the terminals in the network, and their current status.

The call processing servers are examples of users of the services provided in the particular network. The term user refers to any client who may use the service or functionality provided by the network operator or a network entity in one of the domains of the network operator.

In accordance with an embodiment of the present invention, there is provided a broker entity 114 associated with, and common to, both of the networks 102 and 104. Each of the HSS 106 and the CPS 108 of the first network are connected to the common broker entity 114 via respective communication links 116 and 118. Each of the HSS 110 and the CPS 112 of the second network are connected to the common broker entity 114 via respective communication links 120 and 122.

The respective HSS and CPS entities communicate with the broker entity 114 on the communication links 116, 118, 120 and 122 using an appropriate known application protocol (AP), for example MAP over TCAP or CAP over TCAP. In the illustrative example shown in FIG. 1, it is assumed that the application protocol used is MAP over IP.

The communication link 116 represents a first SCTP association, the communication link 118 represents a second STCP association, the communication link 120 represents a third STCP association, and the communication link 122 represents a fourth SCTP association.

In the example of FIG. 1, the broker entity also utilises a MAP over IP protocol, establishing a fifth SCTP association between the respective networks.

The broker entity is preferably a host running SCTP over IP, with the necessary user application protocol (e.g. M3UA, SUA, etc.).

The broker entity is used when a mobile user normally connected in one network is temporarily connected in another network—a foreign network. For example, a mobile user normally connected in network 102 may be temporarily connected in network 104.

In such a scenario the mobile user registered in the foreign network must communicate with its home network in order to access, for example, accounting records, authorization information, subscriber data and settings, and services in the home network. In accordance with the described embodiment of the present invention, this information is accessed by communications sent via the broker entity 114.

For the purpose of understanding the present invention, an example communication between the two operator networks of FIG. 1 will now be described with additional reference to FIG. 5. For the purposes of this example it is assumed that a mobile user for which the first network 102 is the home network, is currently in the area of operator 2 and wishes to be connected in the second network 104.

In accordance with known techniques, the mobile user attempts to register with the second network 104. The call processing server (CPS) 112 of the second network 104 then carries out the appropriate functional steps to determine if the mobile user may be connected in the second network. In accordance with known techniques, the mobile user provides the call processing server of the second network with information identifying it's home network, in this case the first network 102. As part of the registration of the mobile user in the second network 104, the call processing server 112 must check the subscription data of the mobile user. To do this, the call-processing server 112 must verify subscription data of the mobile user with its home network.

In accordance with this embodiment of the present invention, the call processing server 112 sends a request to the first network 102 via the common broker 114. The request, as represented by signal 502 in FIG. 5, is a request to check the subscription data for the mobile user.

The common broker 114 is configured to accept all signalling connections from the second network which are intended for the first network. The common broker can filter out any other messages, for example by using a firewall functionality. The common broker may also be used to limit the connection of other operators to a network with which it is associated.

The common broker 114 analyses any received message and if it determines that the message is for receipt by a network for which it acts as broker, then determines which network element of that network the message should be forwarded to. If implemented, the common broker may utilise a load-sharing/load balancing mechanism in determining where the message should be sent.

In the present described example, the request message is forwarded by the common broker to the home subscriber server 106, as represented by signal 504 in FIG. 5.

A home location register (HLR) associated with the home subscriber server, represented as a functional block 506 in FIG. 5, receives the request message as represented by signal 508.

The home location register handles the request message by confirming the mobile user's subscriber information. The handling of the request message by the home location register is in accordance with known techniques.

As represented by message 510, the home location register sends a reply to the home subscriber server, which in turn sends a reply message to the common broker, as represented by message 512.

The common broker then forwards the reply to the original requester, in this case the call-processing server 112, as represented by message 514.

It accordance with the present invention, the broker entity provides interconnection services between different operator networks; addressing functionality between the different operator networks; and simplifies the interconnection between different operator networks.

The broker entity may also provide, in embodiments, load sharing; network confidentiality; security functionality (i.e.—firewall functions); and a way for operators to dynamically provide inter-work and roaming capacities.

In the example described hereinabove with reference to FIGS. 1 and 5, the broker may hide the exact configuration data of the second network for the first network in the process of transmitting messages. In this way the broker may prevent information about one network being visible to another network.

The location of the common broker entity 114 in the embodiment of FIG. 1 is implementation dependent. For example, the broker may be provided In on a third party server entirely independent of the networks, or it may be provided on a server having functionality split across the networks with which it is associated.

Referring to FIG. 2, there is illustrated the protocol stack for the communication arrangement of FIG. 1.

Generally illustrated by block 202 there is shown the protocol layers in the first network for communication with the broker entity. Generally illustrated by block 204 there is shown the protocol layers in the second network for communication with the broker entity. Generally illustrated by block 206 there is illustrated the protocol stack of the broker entity, having a portion 208 associated with the first network and a portion 210 associated with the second network.

The protocol layers 204 in the first network comprise an Internet protocol (IP) layer 212, a SCTP layer 214, a UA layer 216 and an application protocol (AP) layer 218. The protocol layers 206 in the second network comprise an Internet protocol (IP) layer 220, a SCTP layer 222, a UA layer 224 and an application protocol (AP) layer 226. Each of the protocol layers of the broker entity comprises an Internet protocol (IP) layer 228, an SCTP layer 230, and a user application (UA) layer 232. The broker entity also includes a broker function 234.

The protocol stack layers shown in blocks 202 and 204 illustrate conventional protocol stacks. FIG. 2 shows that the first and second networks have a user application layer. In practice, the user application layer for each network may differ, and the appropriate application layer in the broker entity will mirror the application layer in the network. The broker function, represented by layer 234, takes place above the application layer. As discussed hereinabove the broker function may include functionality to remove or hide information concerning the structure of the two or more networks interconnected by the broker.

The SCTP and IP layers 230 and 228 represent the SCTP-over-IP transmission.

The protocol stack shown in FIG. 2 does not illustrate any modifications over a conventional protocol stack structure. The present invention resides in the implementation of the broker function in the layer 234.

Referring to FIG. 3, a further example implementation of the present invention is shown. In FIG. 3, like reference numerals are used to illustrate elements corresponding to those shown in FIG. 1. The example implementation of FIG. 3 differs from that of FIG. 1 in that a shared or common broker is not provided. Instead, the respective first and second networks are provided with first and second brokers, identified by reference numerals 302 and 304. The first and second brokers are linked together by a communication link, as represented by line 306.

The principle of operation of the brokers 302 and 304 as shown in FIG. 3 is the same as that of the common broker 114 of FIG. 1.

In an arrangement such as is shown in FIG. 3, all communications between the respective networks may be provided via the respective brokers. Thus when a mobile user having the first network 102 as its home network is to be connected in the second network 104, the call processing server 112 forwards a request message to the broker 304, which in turn forwards the request message to the broker 302. The broker 304 is configured to carry out the broker functionality of removing any information from the communication which is to be hidden from the other network. The request message received by the broker 302 is processed and forwarded to the appropriate network element in the first network as described hereinabove with reference to FIG. 1.

In an alternative, when a mobile user registers in a foreign network, the call-processing server in that foreign network may communicate directly with the broker associated with the home network of the mobile user.

Whilst the invention may utilised with a network having a broker entity communicating with a network not having a broker entity, the preferable implementation of the invention is for use in communication between networks having respective broker entities or shared brokers.

For completeness, FIG. 4 illustrates the protocol stack for the example of FIG. 3. Again like reference numerals refer to elements in FIG. 4 which correspond to elements in FIG. 2. The protocol stacks 202 and 204 associated with the first and second networks are identical to those of FIG. 2.

As two separate brokers are provided in FIG. 3, there is shown in FIG. 4 a protocol stack corresponding to each of the brokers.

Protocol stack 402 refers to the broker 302, and includes a broker function 412 and a UA layer 410. The network side of the broker has an IP layer 406, and an SCTP Layer 408 for SCTP over IP transmission within the network, and the broker side of the has an IP layer 414 and an SCTP Layer 416 for SCTP over IP transmissions external to the network.

Protocol stack 404 refers to the broker 304, and includes a broker function 422 and a UA layer 420. The network side of the broker has an IP layer 426, and an SCTP Layer 428 for SCTP over IP transmission within the network, and the broker side of the has an IP layer 424 and an SCTP Layer 436 for SCTP over IP transmissions external to the network.

The broker entities used by the present invention are required to be reachable by other brokers, for example other brokers in a global 3G network. Each broker must manage SCTP connections to other brokers. Each broker must also have the functionality to multiplex SCTP-data from several sources, and establish new connections when needed.

The user adaptation protocols are required to reach the brokers and translate between private addresses and public addresses.

There are many advantages associated with the present invention. The broker entity, acting as a signalling broker, simplifies the signalling connection management between networks. Network elements only need connections to a broker, not to all of the network elements in other networks. Thus the broker entity preferably provides connection management between the local and foreign networks.

The broker may apply filtering rules to eliminate unwanted signalling into the operator's network. The broker may thus include a traffic filter. The traffic filter may be utilised to block certain traffic. This may be implemented, for example, as a firewall. The implementation of such a traffic filter will be familiar to one skilled in the art.

If duplicate network elements are provided in a network, the broker associated with that network may use load sharing or load-balancing mechanisms to distribute the processing load amongst those network elements having duplicate functionality. To provide such functionality, the broker entity may be provided with a load balancer. The implementation of such a load balancer will be familiar to one skilled in the art.

In order to ensure the correct direction of traffic, the broker entity is also preferably provided with an address selector. This may, in particular, be used in conjunction with the load balancer. The address selector selects the endpoint address within the network.

The use of the broker entities also simplifies external addressing. Other network operators only need to maintain the address of the broker of a particular network, rather than the address of all the elements within that network.

The provision of the broker entity advantageously acts as a gateway for a network. The broker entity allows: the network structure to be hidden; the possibility of insertion of a firewall; the multiplexing of traffic; and possibility of performing protocol conversion if networks are not compatible.

There are many operators operating IP networks. The provision of a broker entity according to the present invention facilitates an efficient management of connections to many or all network elements in different operator networks, and thereby avoids huge scalability problems which would otherwise exist. Without the provision of a broker entity according to the present invention, the scalability problems are such that connection management between network elements would be inoperable.

The broker entity furthermore advantageously provides a technique for distributing information about new network elements, or performing change-over procedures. By placing all the network elements behind a single broker entity, scalability problems are solved by the limitation of connections to broker entity-to-broker entity.

In addition, the invention allows network operators flexibility to configure and maintain their networks behind the broker entity. As such, it is easier to add and remove network elements as only the broker entity needs to be informed of such changes, as opposed to all of the network elements in all of the operator networks.

It should be noted that whilst the present invention is described herein with reference to particular examples, it is not limited to such examples. The data network between IP networks may not be the Internet, but may be other forms of internet such as an intranet or an extranet. In particular the present invention is not limited in its applicability to transmission using SCTP over IP. One skilled in the art will appreciate the general applicability of the present invention, which is limited in scope only by the appended claims.

1-34. (canceled)

35. A broker entity for a first IP network, the first IP network being adapted to communicate with a second IP network via at least one data network, wherein communication between the first IP network and the second IP network is via the broker entity.

36. The broker entity of claim 35, wherein said broker entity is common to the second IP network.

37. The broker entity of claim 35, wherein the second IP network is provided with a second broker entity.

38. The broker entity of claim 37 wherein communication between the first and second IP networks is via the first and second brokers.

39. The broker entity of claim 35, wherein the data network is one of: the Internet, an intranet, or an extranet.

40. The broker entity of claim 35, further including a traffic filter.

41. The broker entity of claim 40 wherein the traffic filter includes a firewall.

42. The broker entity of claim 35 further including a load balancer.

43. The broker entity of claim 35 further including an address selector.

44. The broker entity of claim 43 wherein the address selector selects a network endpoint.

45. The broker entity of claim 35 further including a connection manager.

46. The broker entity of claim 35, wherein the network is a wireless network.

47. The broker entity of claim 35, wherein the broker entity is adapted to operate under SCTP and a user application protocol.

48. The broker entity of claim 47, wherein the user application protocol is M3UA.

49. The broker entity of claim 35, wherein the broker entity is adapted to act as a gateway for the first IP network.

50. The broker entity of claim 49, wherein the broker entity is adapted to allow multiplexing of traffic.

51. The broker entity of claim 49, wherein the broker entity is adapted to allow performing protocol conversion if the first IP network and the second IP network are not compatible.

52. The broker entity of claim 35, wherein the broker entity is a signalling broker adapted for signalling.

53. A method of communicating between a first IP network and a second IP network via at least one data network, the method comprising providing a broker entity in the IP network, wherein communication between the first and second IP networks is via the broker entity.

54. The method according to claim 53, wherein said broker entity is common to the second IP network.

55. The method according to claim 53, wherein the second IP network is provided with a further broker entity.

56. The method of claim 53, wherein the data network is one of: the Internet, an intranet, or an extranet.

57. The method of claim 53 wherein the broker entity performs traffic filtering.

58. The method of claim 53 wherein the traffic filtering is performed by a firewall.

59. The method of claim 53 wherein the broker entity performs load balancing.

60. The method of claim 53 wherein the broker entity performs address selection.

61. The method of claim 60 wherein the address selection identifies a network endpoint.

62. The method of claim 53 wherein the broker entity performs connection management.

63. The method of claim 53, wherein the broker entity operates under SCTP and a user application protocol.

64. The method of claim 63, wherein the user application protocol is M3UA.

65. The method of claim 53, wherein the broker entity acts as a gateway for the first IP network.

66. The method of claim 65, wherein the broker entity allows multiplexing of traffic.

67. The method of claim 65, wherein the broker entity allows performing protocol conversion if the first IP network and the second IP network are not compatible.

68. The method of claim 53, wherein the broker entity is a signalling broker adapted for signalling.
